(19) United States
(12) Patent Application Publication
(10) Pub. No.: US 2009/0285467 A1
(43) Pub. Date: Nov. 19, 2009

(54) METHOD FOR ASSESSING BONE STATUS

(75) Inventors: Jyh-Cheng Chen, Taipei City (TW); Chih-Chieh Chang, Taipei City (TW)

Correspondence Address: KIRTON AND MCCONKIE, 60 EAST SOUTH TEMPLE,, SUITE 1800, SALT LAKE CITY, UT, 84111, US

(73) Assignee: NEW MEDICAL CO., LTD., Taipei (TW)

(21) Appl. No.: 12/121,127

(22) Filed: May 15, 2008

(51) Int. Cl. G06K 9/00

(52) U.S. Cl. 382/132

(57) ABSTRACT

A method for assessing bone status is disclosed. The method for assessing bone status comprises steps of: obtaining a chest radiograph, recognizing a target bone on the chest radiograph by active shape models, detecting edges of a cortical bone of the target bone by intelligent scissors, and calculating a parameter of bone status through the cortical bone. The present invention increases the diagnosis value of the chest radiography and provides a simple, economic, rapid and reliable assessment of bone status.

### FIELD OF THE INVENTION

The present invention relates to a method for assessing bone status, and more particularly to a method for assessing bone status from a chest radiograph.

### BACKGROUND OF THE INVENTION

Osteoporosis is a condition of reduced bone mass, which affects the whole skeleton to a similar degree and leads to a reduced strength of the bone and therefore an increased risk of fractures, in particular at the hip, the vertebrae and the wrist. Especially for the women after menopause, changes in hormone levels cause the rapid loss of bone mass, so the women suffer the osteoporotic hip fracture in much higher percentage than men. Therefore, it is an important issue to assess bone status to diagnose potential bone diseases, monitor the course of suspected osteoporosis or follow the effect of therapy.

The main assessment of bone status is to measure the bone mineral density (BMD), which is the weight of calcium per projected bone area. The most common technique to measure the BMD is dual energy X-ray adsorption (DEXA). However, the DEXA equipment is very expensive and only equipped in medical center or large hospital, and the patient needs to arrange schedule for examination, which is inconvenient and costly.

Accordingly, there is a need for alternative, more accessible and economic method for assessing bone status.

### SUMMARY OF THE INVENTION

An object of the present invention is to provide a method for assessing bone status by effectively recognizing the clavicle on the chest radiograph with the techniques of active shape models and intelligent scissors, so as to obtain geometric information of the clavicle and further calculate parameters of bone status. The present invention increases the diagnosis value of the chest radiography and provides a simple, economic, rapid and reliable assessment of bone status, and thus, many bone diseases can be early detected and the patients can have early treatment.

According to an aspect of the present invention, there is provided a method for assessing bone status, comprising steps of: obtaining a chest radiograph; recognizing a target bone on the chest radiograph by active shape models; detecting edges of a cortical bone of the target bone by intelligent scissors; and calculating a parameter of bone status through the cortical bone.

Preferably, the chest radiograph is a digital chest radiograph.

In an embodiment, the method for assessing bone status further comprises a step of scanning the chest radiograph into image data when the chest radiograph is an X-ray film.

In an embodiment, the target bone is clavicle.

In an embodiment, the method for assessing bone status further comprises a step of determining width of the target bone and thickness of the cortical bone.

In an embodiment, the parameter of bone status is volume per projection area (VPA) of the cortical bone, which is derived from the following equation:

VPA=T×(W−T)×π÷W

Where T represents the thickness of the cortical bone and W represents the width of the target bone.

In an embodiment, the parameter of bone status is bone volume ratio (BVR) by calculating a ratio of the cortical bone volume to total bone volume. The BVR is derived from the following equation:

BVR=4×T×(W−T)÷W²

Where T represents the thickness of the cortical bone and W represents the width of the target bone.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 shows the shape of the clavicle is marked for training set of active shape models;

FIG. 2 shows possible shapes of the clavicle in three directions of deformation within 3 standard eigenvectors;

FIG. 3 shows a preliminary position for searching the clavicle is given by a mouse;

FIG. 4 outlines the real shape of the clavicle by means of the active shape models with intelligent scissors;

FIG. 5 shows the edge detection result, wherein the outer line shows the edge of the clavicle detected by the active shape models with the intelligent scissors and the inner line shows the edge of the cortical bone detected by the intelligent scissors;

FIG. 6 shows the diagram of bone structure;

FIG. 7 shows the assessed VPA in the young group and the old group;

FIG. 8 shows the assessed BVR in the young group and the old group;

FIG. 9 shows the correlation between the assessed VPA and BMD of lumbar vertebra; and

FIG. 10 shows the correlation between the assessed BVR and BMD of lumbar vertebra.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The chest X-ray is the most commonly performed radiographic examination and is a routine examination for health examination and pre-hospitalization examination. The present invention provides a method for assessing bone status from a chest radiograph by determining the width of the target bone and the thickness of the cortical bone of the target bone and further calculating the parameter of bone status. In the present invention, the clavicle is targeted and analyzed; however, the present invention is not limited to analyze the clavicle, and other bones, such as the sternum and the rib, on the chest radiograph can also be applied to the techniques of the present invention.

Since the technology of digital image has been well developed and widely used, the result of the chest X-ray is mostly transformed into digital image nowadays and is ready to be analyzed. However, the present invention is applied to not only the digital chest radiograph, but also the traditional X-ray film, which can be scanned into the digital image; hence, the prior X-ray films from previous health examinations can also be further analyzed to observe the bone status change with the growing age.

According to the preferred embodiment of the present invention, the method for assessing bone status mainly includes steps of: obtaining a chest radiograph; recognizing a target bone on the chest radiograph by active shape models; detecting edges of a cortical bone of the target bone by intelligent scissors; and calculating a parameter of bone status through the cortical bone. The detailed processes will be described as follows.

“Active shape models” is proposed in 1995 to recognize and locate objects, whose appearances can vary through time or between individuals, in noisy and cluttered images. This technique builds models by learning patterns of variability from a training set of correctly annotated images, and can be used in image search to find objects of the structures that they represent. The theory of the active shape models is presented in T. F. Cootes, C. J. Taylor, D. H. Cooper, J. Graham, Active Shape Models—Their Training and Application, Computer Vision and Image Understanding, Vol. 61, No. 1, pp. 38-59, January 1995.

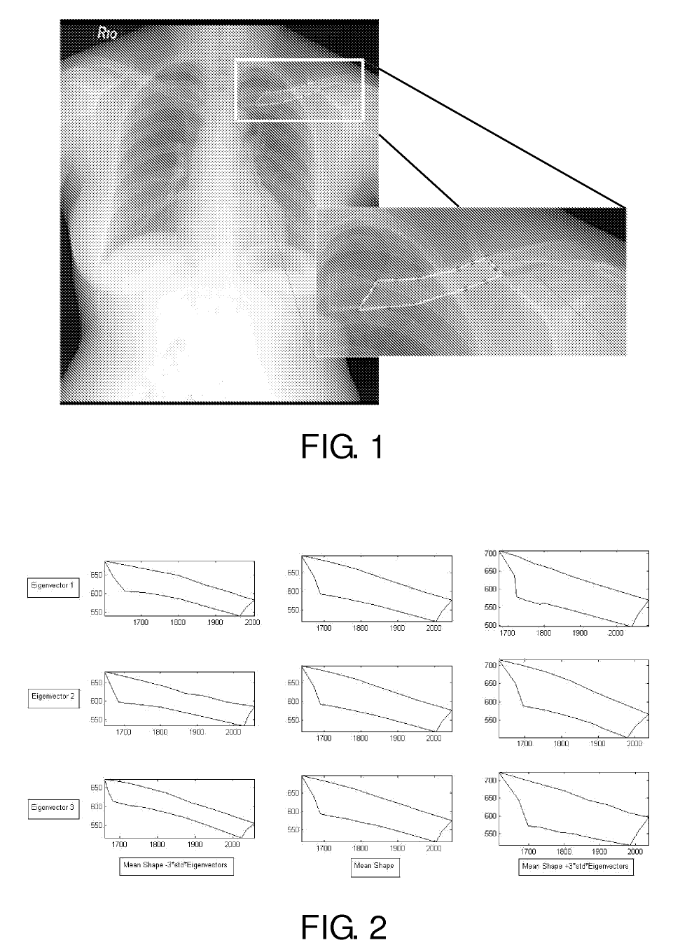

In the present invention, 50 chest radiographs are collected and the boundary of the left clavicle is labeled manually with 16 points on each chest radiograph to mark the shape of the clavicle (as shown in FIG. 1). Then, all shapes in the training set are aligned for principle component analysis and further getting a point distribution model by statistics. Through the training set, the mean shape of the clavicle and the directions of deformation can be obtained. FIG. 2 shows possible shapes of the left clavicle in three directions of deformation within three standard deviations.

Parameters, such as the search time and the deformation limit, need to be set for object recognition. For example, the search iteration is 100 times and the deformation limit is one standard deviation along each deformation direction. Since the clavicle usually does not deform greatly, the deformation limit can be one standard deviation; however, when the clavicle to be searched has a considerable deformation, the deformation limit can be increased to three standard deviations.

Although the active shape models technique can recognize the shape of the clavicle, the shape is defined by the points and the connecting line between points cannot represent the real edge of the clavicle. Therefore, the present invention further uses intelligent scissors to detect the edge of the clavicle.

Intelligent scissors allow objects within digital images to be extracted quickly and accurately using simple gesture motions with a mouse. When the gestured mouse position comes in proximity to an object edge, a live-wire boundary “snaps” to, and wraps around the object of interest. The theory of the intelligent scissors is presented in Eric N. Mortensen, William A. Barrett, Intelligent Scissors for Image Composition, Proceedings of the 22nd annual conference on Computer graphics and interactive techniques, pp. 191-198, September 1995.

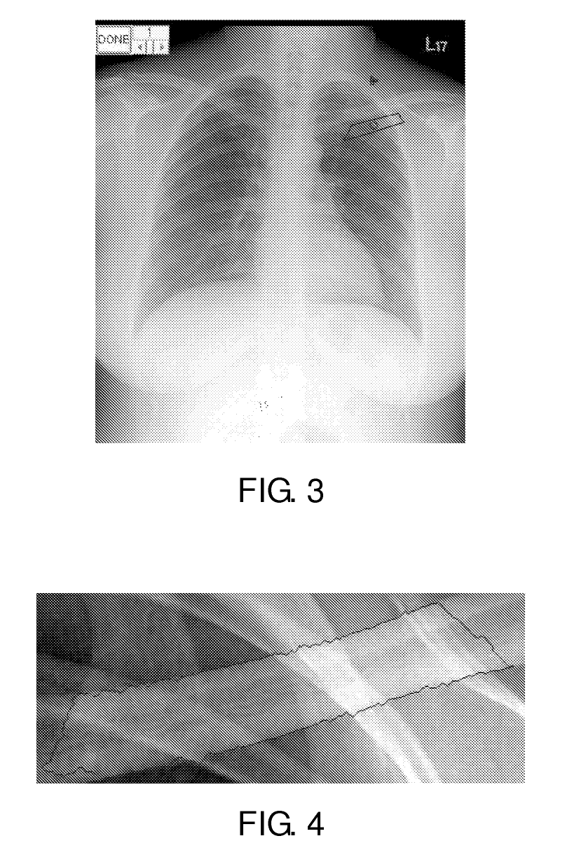

Please refer to FIG. 3. When a chest radiograph is obtained, a preliminary position for searching the clavicle is given by a mouse. Then the clavicle is recognized by the active shape models. At the moment, the point distribution of the clavicle provided by the active shape models replaces the gesture motions with a mouse used in the ordinary intelligent scissors, and the edge of the clavicle is detected by the intelligent scissors. The search result is shown in FIG. 4, which outlines the real shape of the clavicle.

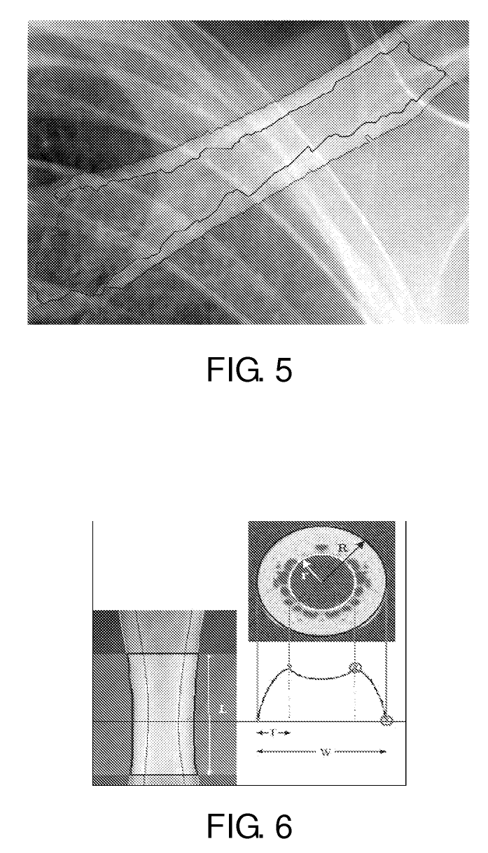

Moreover, the intelligent scissors tool is further used to detect the edges of the cortical bone of the clavicle. After the clavicle is located, the edge of the cortical bone is semi-automatically detected by the intelligent scissors with the assistance of the mouse. FIG. 5 shows the edge detection result, wherein the outer line shows the edge of the clavicle detected by the active shape models with the intelligent scissors and the inner line shows the edge of the cortical bone detected by the intelligent scissors.

Since the edges of the clavicle and its cortical bone are detected, the width of the clavicle and the thickness of the cortical bone can be determined. It is known that the cortical bone loss is age-related, so the volume ratio of the cortical bone can be used as a parameter for assessing bone status. In the present invention, the volume per projection area (VPA) of the cortical bone can be calculated by the following modified equation:

$$\begin{matrix}V P A = ( cortical bone volume ) / ( projection area ) \\ = T \times ( W - T ) \times π \div W\end{matrix}$$

wherein T represents the thickness of the cortical bone and W represents the width of the clavicle.

The present invention further proposes another bone status parameter named bone volume ratio (BVR) by calculating the ratio of the cortical bone volume to the total bone volume as:

$$\begin{matrix}B V R = ( cortical bone volume ) / ( total bone volume ) \\ = [ ( π \times W \times T - π \times {T}^{2} ) \times L ] / [ π \times {( W / 2 )}^{2} \times L ] \\ = 4 \times T \times ( W - T ) \div {W}^{2}\end{matrix}$$

wherein T represents the thickness of the cortical bone, W represents the width of the clavicle, and L represents the length of the clavicle (as shown in FIG. 6).

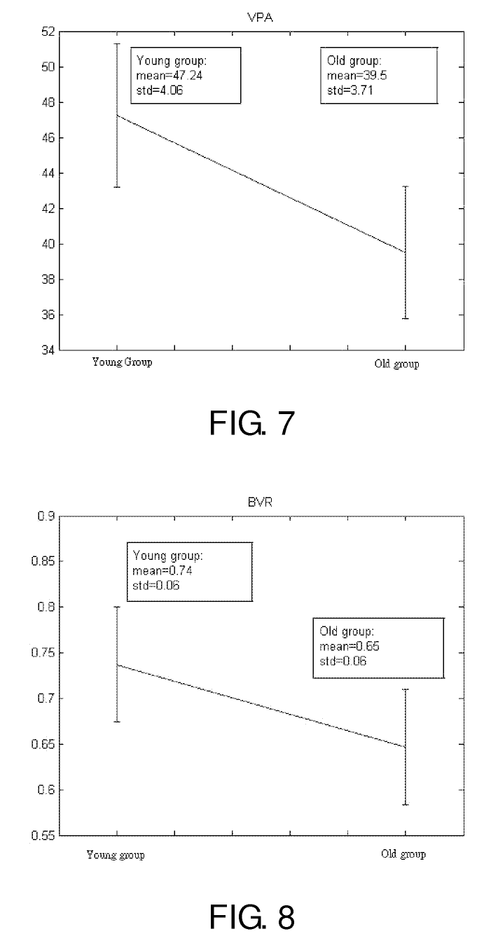

To evaluate the method for assessing bone status provided by the present invention, two groups of chest radiographs, according to the menopausal age (50), are collected. The first group is the young group whose ages ranged from 37 to 41, and the analyzed number is 29. The second group is the old group whose ages ranged from 55 to 72, and the analyzed number is 18. The results of the assessed bone status parameters, i.e. VPA and BVR, are listed in Table 1 and shown in FIGS. 7 and 8.

TABLE 1

| | VPA mean | VPA std | BVR mean | BVR std |
|---|---|---|---|---|
| Young group | 47.24 | 4.06 | 0.74 | 0.06 |
| Old group | 39.5 | 3.71 | 0.65 | 0.06 |

The VPA mean of the young group is 47.24 with the standard deviation of 4.06, and the VPA mean of the old group is 39.5 with the standard deviation of 3.71. The BVR mean of the young group is 0.74 with the standard deviation of 0.06, and the BVR mean of the old group is 0.65 with the standard deviation of 0.06. After T-test analysis, significant differences are found between the young group and the old group (p<0.05) for both VPA and BVR evaluations. Both VPA and BVR are lower in post-menopausal group than the group before menopause.

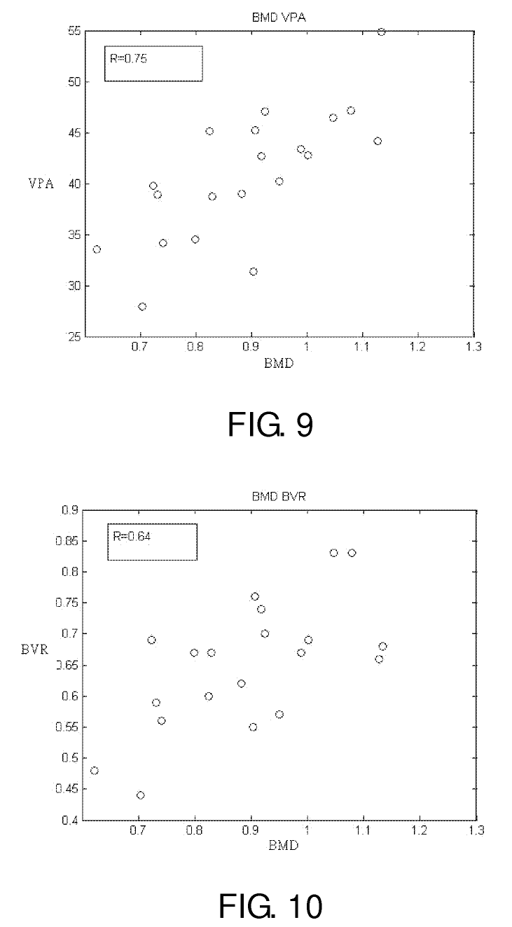

Further, the correlation between the VPA or the BVR and the bone mineral density (BMD) of lumbar vertebra is analyzed for the same 20 samples and shown in FIGS. 9 and 10, wherein the correlation coefficient between the VPA and the BMD is 0.75, and the correlation coefficient between the BVR and the BMD is 0.64. Therefore, both the VPA and the BVR have certain correlation with the BMD of lumbar vertebra, and it is believed the correlation between the VPA or the BVR and the BMD will be more specific correlative if the BMD is measured from the clavicle.

From the above, after recognizing the clavicle on the chest radiograph by active shape models and detecting edges of the cortical bone of the clavicle by intelligent scissors, the geometric information of the clavicle, such as the width of the clavicle and the thickness of the cortical bone, can be determined. Accordingly, the parameters, such as the VPA and the BVR, can be calculated and used for the assessment of bone status.

In conclusion, the present invention provides a method for assessing bone status by effectively recognizing the clavicle on the chest radiograph with the techniques of the active shape models and the intelligent scissors, so as to obtain geometric information of the clavicle and further calculate parameters of bone status. Since the chest radiography is a routine health examination, people do not need to take other radiographic examination or cost more money and time for DEXA examination, and the hospital can reduce the cost for DEXA equipment. By the method of the present invention, the databases of the chest radiograph analysis of the VPA and the BVR can be established for health evaluation and are potential to estimate the BMD. Moreover, the present invention increases the diagnosis value of the chest radiography and provides a simple, economic, rapid and reliable assessment of bone status, and thus, many bone diseases can be early detected and the patients can have early treatment.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for assessing bone status, comprising steps of:
obtaining a chest radiograph;
recognizing a target bone on the chest radiograph by active shape models;
detecting edges of a cortical bone of the target bone by intelligent scissors; and
calculating a parameter of bone status through the cortical bone.

2. The method for assessing bone status according to claim 1 wherein the chest radiograph is a digital chest radiograph.

3. The method for assessing bone status according to claim 1 further comprising a step of scanning the chest radiograph into image data when the chest radiograph is an X-ray film.

4. The method for assessing bone status according to claim 1 wherein the target bone is clavicle.

5. The method for assessing bone status according to claim 1 further comprising a step of determining width of the target bone and thickness of the cortical bone.

6. The method for assessing bone status according to claim 5 wherein the parameter of bone status is volume per projection area (VPA) of the cortical bone.

7. The method for assessing bone status according to claim 6 wherein the VPA is derived from the following equation:
VPA=T×(W−T)×π÷W
wherein T represents the thickness of the cortical bone and W represents the width of the target bone.

8. The method for assessing bone status according to claim 5 wherein the parameter of bone status is bone volume ratio (BVR) by calculating a ratio of the cortical bone volume to total bone volume.

9. The method for assessing bone status according to claim 8 wherein the BVR is derived from the following equation:
BVR=4×T×(W−T)÷W²
wherein T represents the thickness of the cortical bone and W represents the width of the target bone.
